(19) United States
(12) Patent Application Publication
(10) Pub. No.: US 2013/0212918 A1
(43) Pub. Date: Aug. 22, 2013

(54) KINETIC ARTWORK DISPLAY

(71) Applicant: Dominic Pangborn, Detroit, MI (US)

(72) Inventor: Dominic Pangborn, Detroit, MI (US)

(21) Appl. No.: 13/847,304

(22) Filed: Mar. 19, 2013

Related U.S. Application Data
(63) Continuation of application No. 13/006,995, filed on Jan. 14, 2011, now abandoned.

(51) Int. Cl. G09F 19/14

(52) U.S. Cl. CPC G09F 19/14
USPC 40/453

(57) ABSTRACT

Described herein is a kinetic artwork display wherein an image is displayed on a non-planar frame. Due to shading, the image appears concave to the observer, when in fact, the surface is convex. These displays may be used in advertising or packaging.

This application claims the benefit of U.S. Provisional Applications No. 61/294,908, filed Jan. 14, 2010, and 61/367,751, filed Jul. 26, 2010, the contents of which are incorporated herein by reference.

Embodiments of the invention relate generally to the field of displays for artistic works and more particularly to the display of three-dimensional artworks. These displays may be used in advertising or packaging.

Displays that are shaped in a pleated or accordion-style manner can be used to display multiple images, where the image seen by the viewer depends on the position of the viewer. Such artwork images are often called kinetic artwork or kinetic artwork images, and are generally discussed in the U.S. Pat. No. 6,306,479.

Reverspectives are three-dimensional paintings that when viewed from the front initially give the impression of viewing a painted flat surface that shows a perspective view. However as soon as the viewer moves their head even slightly the three dimensional surface that supports the perspective view accentuates the depth of the image and accelerates the shifting perspective far more than the brain normally allows. This provides a powerful and often disorienting impression of depth and movement.

The illusion is made possible by painting the view in reverse to the relief of the surface, that is, the bits that stick furthest out from the painting are painted with the most distant part of the scene.

In accordance with an aspect of the invention, there is provided an advertising artwork display comprising; (a) an image, in a non-planar display configuration, wherein the image comprises a plurality of surfaces for displaying different portions of the image at different angles, relative to the base; and (b) a display frame for supporting the image in the non-planar display configuration. The display frame comprises a plurality of raised prismatic structures for positioning the plurality of surfaces at a non-zero angle relative to the base.

The use of kinetic art in advertising has several advantages. Creating ads or product info onto the artwork display structure creates optical movement. The images will move as the viewer moves. When potential customers drive past a billboard, the images move without any mechanical structure. For legal outdoor usage, there are no moving parts or any special electric work, other than modified lighting. The same advantages apply to packaging and other advertising.

The reverspective effect can be achieved by stacking packaging utilizing appropriate graphics, such as at end caps of aisles in retail stores, thus drawing the attention of the customer to the product.

Trade show displays could also use this approach to create visually distinct exhibits. Simple foam board (or other materials known in the art) may be arranged in an undulating pattern using appropriate graphics to create the reverspective effect.

### BRIEF DESCRIPTION OF THE DRAWINGS

For a better understanding of embodiments of the invention, and to show more clearly how they may be carried into effect, reference will now be made, by way of example, to the accompanying drawings in which:

FIG. 1. is a side view of the display showing the raised prismatic structures attached to the base.

FIG. 2. is an overhead view of sample prismatic structures.

FIG. 3. is an example of an image showing the reverse shading, in a planar display.

FIG. 4. is an example of an entire kinetic artwork image, in a planar display.

FIG. 5. shows an example of tissue boxes side to side, creating a reverspective display.

FIG. 6. shows trigonal prismatic boxes arranged to create a reverspective display.

Aspects of the invention involve a display assembly comprising an image in a non-planar configuration. The image has a plurality of surfaces for displaying different portions of the image at different angles. The image is shaded so that the surfaces of the prisms appear to be concave to the observer. The display assembly further comprises a display frame for supporting the image in the non-planar configuration. The display frame, in turn, includes raised prismatic structures for positioning the surfaces at a non-zero angle relative to the base.

Features of various embodiments of the invention are discussed in greater detail below with reference to the appended figures.

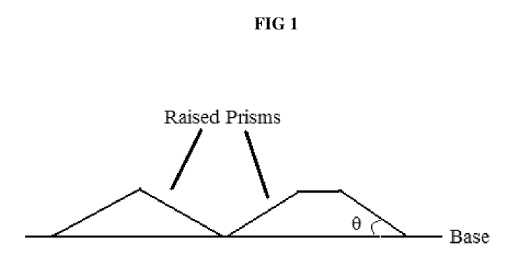

With reference to FIG. 1/6, the base has a plurality of raised prismatic structures arranged side-by-side. The angle θ formed by the surface of the base and the adjacent prismatic structure is between 1 degree and 89 degrees. More preferably between 15 and 75 degrees. More preferably between 30 and 60 degrees.

The shape of the prismatic structures is chosen from frustum (truncated pyramid) and wedge, as shown in

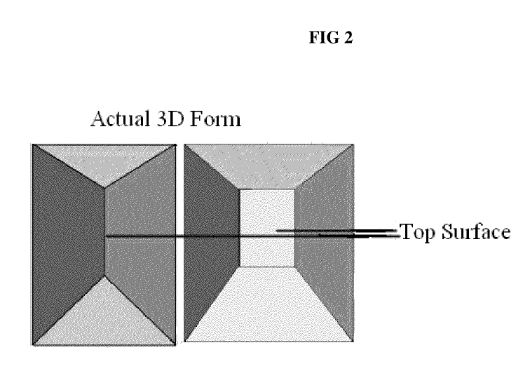

FIG. 2/6 The prismatic structures are made from structural materials such as paper, cardboard, plastic and wood.

The display base is made from a resilient planar material, such as a thin sheet of cardboard. In some embodiments, the display frame can be made from materials such as plastic or foam sheet, cardstock, heavy paper or other suitably resilient materials.

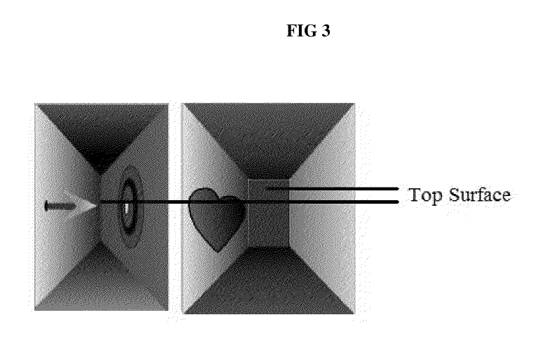

In FIG. 3/6, the kinetic artwork insert is shown in its planar configuration. The shading of the insert gives the illusion of concavity. Shading is done in a manner to having the foreground dark and farthest element is light, therefore giving the illusion of reverse.

The kinetic artwork insert comprises a series of surfaces positioned at opposing angles. An observer will observe what appears to be a concave image, when in fact, the surface is convex.

In some embodiments, the kinetic artwork insert is made of original painting on the surface or mounting printed image.

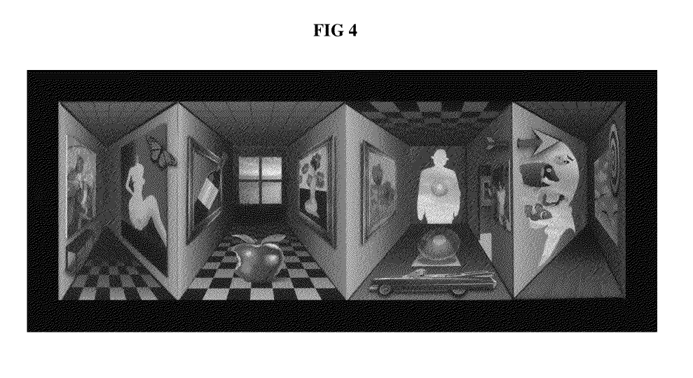

FIG. 4/6 shows a sample kinetic display with the optical illusion of concavity.

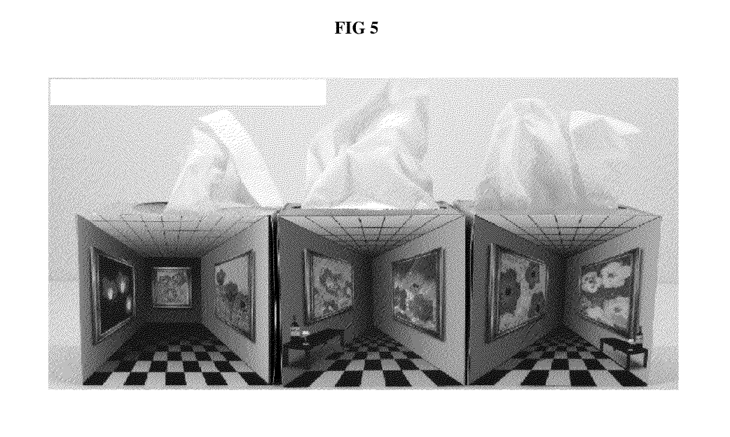

In further embodiments, the kinetic artwork is used in advertising, packaging, endcaps, trade show displays, and point of sales displays. FIG. 5/6 shows an array of tissue boxes with reverspective artwork, creating a visually appealing display.

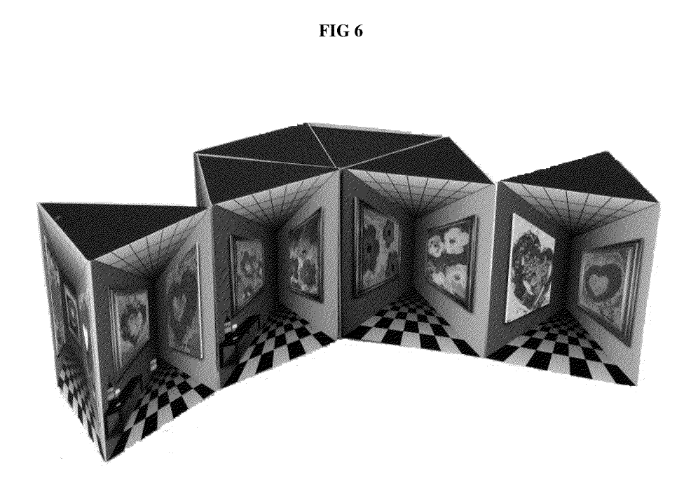

FIG. 6/6 shows an array of boxes arranged to show off the reverspective illusion. Packages such as these could be arranged both vertically and horizontally to create striking in-store sales displays.

In yet further embodiments, the advertising is chosen from billboards, bus sides, trucks, P-O-P on premise, subway and train signage, and mobile billboards.

From the foregoing description, one skilled in the art can easily ascertain the essential characteristics of this invention, and without departing from the spirit and scope thereof, can make various changes and modifications of the invention to adapt it to various usages and conditions.

1. An advertising artwork display comprising;
(a). an image in a non-planar display configuration, wherein the image comprises a plurality of surfaces for displaying different portions of the image at different angles, relative to the base; and
(b). a display frame for supporting the image in the non-planar display configuration comprising a plurality of raised prismatic structures for positioning the plurality of surfaces at a non-zero angle relative to a base.

2. The image as defined in claim 1 wherein the image is shaded so that the surfaces of the prisms appear to be concave to the observer.

3. The display frame as defined in claim 1 wherein the angle θ formed by the surface of the base and the adjacent prismatic structure surface is between 1 degree and 89 degrees.

4. The display frame as defined in claim 3 wherein the angle θ formed by the surface of the base and the adjacent prismatic structure surface is between 15 degrees and 75 degrees.

5. The display frame as defined in claim 4 wherein the angle θ formed by the surface of the base and the adjacent prismatic structure surface is between 30 degrees and 60 degrees.

6. The prismatic structures as described in claim 1 wherein the shapes are chosen from frustum (truncated pyramid) and wedge or any other polyhedral shapes.

7. The prismatic structures as described in claim 1 wherein the structures are made from materials chosen from paper, cardboard, wood, plastic, foam, and metal.

8. The display base as described in claim 1 wherein the base is made from a resilient planar material.

9. The resilient planar material of claim 8 wherein the material is chosen from cardboard, plastic or foam sheet, cardstock, wood, metal and heavy paper.

10. The image insert as described in claim 1 wherein the insert is made from original painting on the surface or any prints on paper or other materials mounted on the surface.

11. The display as described in claim 1, wherein the display is used in packaging, endcaps, trade show displays, and point of sales displays.

12. The display as described in claim 11, wherein the advertising is chosen from billboards, bus sides, trucks, P-O-P on premise, subway and train signage, and mobile billboards.
